(19) United States
(12) Patent Application Publication
(10) Pub. No.: US 2008/0001007 A1
(43) Pub. Date: Jan. 3, 2008

(54) Nozzle having integral injector

(76) Inventors: Rick Gilpatrick, Whitewater, WI (US); Michael James Meyer, Pewaukee, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/472,620

(22) Filed: Jun. 22, 2006

(51) Int. Cl. B05B 7/26

(52) U.S. Cl. 239/310; 239/127; 239/146; 239/526

(57) ABSTRACT

A pressure washer includes a fluid pump operable to supply pressurized water, and a wand for directing the pressurized water. A nozzle body is connected to an end of the wand via a quick disconnect fitting. The nozzle body includes an auxiliary inlet for entraining an auxiliary fluid into the stream of pressurized water via a venturi effect. The nozzle body may be constructed of a single piece of metal such as brass, or a non-metallic material.

### BACKGROUND

The present invention relates to pressure washers and more particularly to pressure washers capable of entraining an auxiliary fluid into a stream of water for distribution with the stream of water. More specifically, the present invention relates to an injector for placing auxiliary fluid into fluid communication with the stream of water.

### SUMMARY

In one embodiment, the invention provides a pressure washer including a fluid pump configured to supply a pressurized primary fluid. A wand includes a first end and a second end, wherein the second end is in fluid flow communication with the fluid pump and is configured to direct the pressurized primary fluid from the second end to the first end. A housing includes an inlet end and an outlet end, wherein the inlet end is coupled to the first end of the wand. A nozzle is positioned in the outlet end of the housing and is adapted to discharge the primary fluid from the pressure washer. An auxiliary inlet is positioned between the inlet end and the outlet end and the auxiliary inlet is in fluid communication with a supply of an auxiliary fluid.

Placing the auxiliary inlet close to the outlet end affords some advantages to the pressure washer. Many existing pressure washers add an auxiliary fluid to the pressurized primary fluid immediately downstream of the fluid pump. Since the auxiliary fluid generally has a greater viscosity or density than the primary fluid, it requires a greater force to push it through a high pressure hose and wand, leading to a high pressure hose being used that is shorter than desired. Adding the auxiliary fluid at the end of the wand reduces the distance the auxiliary fluid will have to be pushed and thus allows a much longer high pressure hose to be used.

In another embodiment, the invention provides a pressure washer including a fluid pump configured to supply a pressurized primary fluid. A wand includes a first end and a second end, wherein the second end is in fluid communication with the pump. A housing is integrally formed as one piece and includes an inlet, an outlet, an auxiliary inlet, and a nozzle formed adjacent the outlet. The inlet is coupled to the first end to receive the pressurized primary fluid.

In another embodiment, the invention provides a non-metallic nozzle housing configured to be coupled to a wand of a pressure washer, the nozzle housing including an inlet end, an outlet end, a fluid flow path between the inlet and outlet ends, a nozzle positioned in the outlet end, and an auxiliary inlet positioned between the inlet end and the outlet end, the auxiliary inlet in fluid communication with a supply of an auxiliary fluid. The nozzle housing is integrally formed as one piece.

Other aspects of the invention will become apparent by consideration of the detailed description and accompanying drawings.

### BRIEF DESCRIPTION OF THE DRAWINGS

FIG. 1 is a perspective view of a pressure washer including a nozzle with an integral injector embodying the present invention;

FIG. 2 is an exploded perspective view of the nozzle and a portion of the pressure washer of FIG. 1;

FIG. 3 is a perspective view of the nozzle of FIG. 1;

FIG. 4 is a side view of the nozzle of FIG. 1;

FIG. 5 is a section view of the nozzle of FIG. 1 taken along line 5-5 of FIG. 3; and

FIG. 6 is a perspective view of an alternative embodiment of the nozzle of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

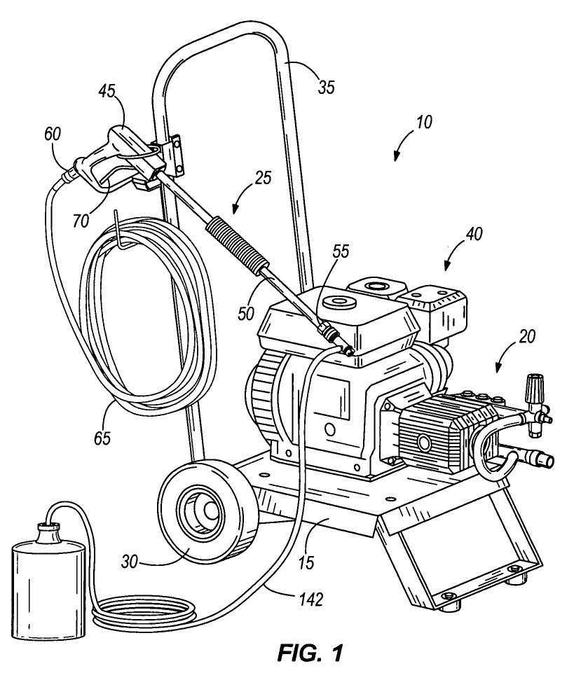

FIG. 1 illustrates a pressure washer 10 that includes a frame 15, a fluid pump 20, and a wand 25. The frame 15 includes wheels 30 and a handle 35 to allow an operator to roll the pressure washer 10 to desired locations. In the illustrated embodiment, the fluid pump 20 includes a connector that facilitates connection to a fluid source. The fluid pump 20 of FIG. 1 is powered by an internal combustion engine 40. In some embodiments, the fluid pump 20 could be powered by an electric motor or any other suitable power source.

The wand 25 includes a wand handle 45, a tube 50, and a nozzle connector 55. The wand handle 45 is generally molded from plastic or another thermally insulative material and includes a fitting 60 that connects the wand handle 25 to a high-pressure hose 65. The hose 65 transports high-pressure fluid from the pump 20 to the wand 25. The wand handle 45 also includes a trigger 70 that controls a valve at least partially internal to the wand handle 45. The valve, when actuated, ports high-pressure water from the fluid pump 20 to the remainder of the wand 25. When not actuated, the valve inhibits flow beyond the wand handle 45.

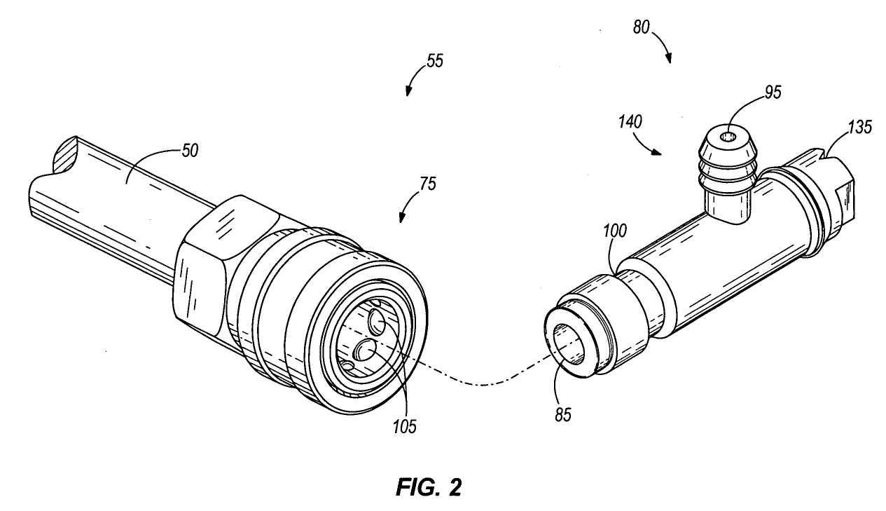

The tube 50 is joined to the wand handle 45 at one end, and receives the nozzle connector 55 at the other end. The nozzle connector 55 of the illustrated embodiment is equipped with a quick-disconnect fitting 75, as shown in FIG. 2. The quick-disconnect fitting 75 allows one of a plurality of nozzles to be individually coupled to the wand 25 at any given time. In other embodiments, the nozzles may be for example, threaded, welded, or press-fit onto the nozzle connector 55, or they may be rigidly connected directly to the tube 50.

When the trigger 70 on the wand 25 is not actuated, the valve remains closed and fluid is not dispensed from the wand 25. When the trigger 70 is actuated, the valve opens and high-pressure flow exits the handle 45 and flows into the tube portion 50 of the wand 25. While the trigger 70 is engaged and the valve remains open, fluid will be pumped continuously through the high pressure hose 65 and the wand 25. Generally, the tube portion 50 of the wand 25 includes a tube that separates the handle 45 from the nozzle connector 55. Circular steel tubes are generally used, with other shapes and materials also being suitable for use.

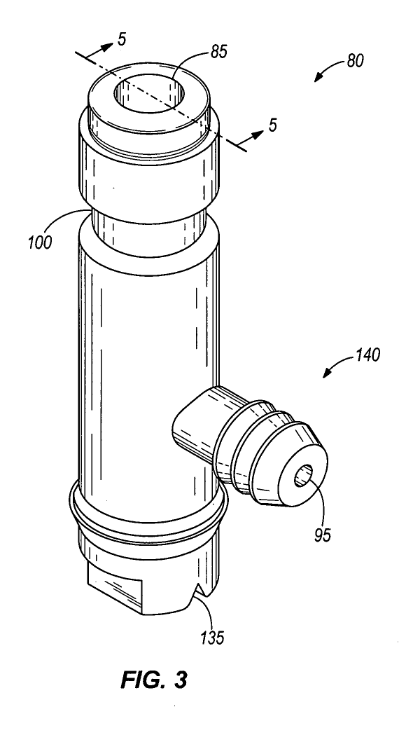

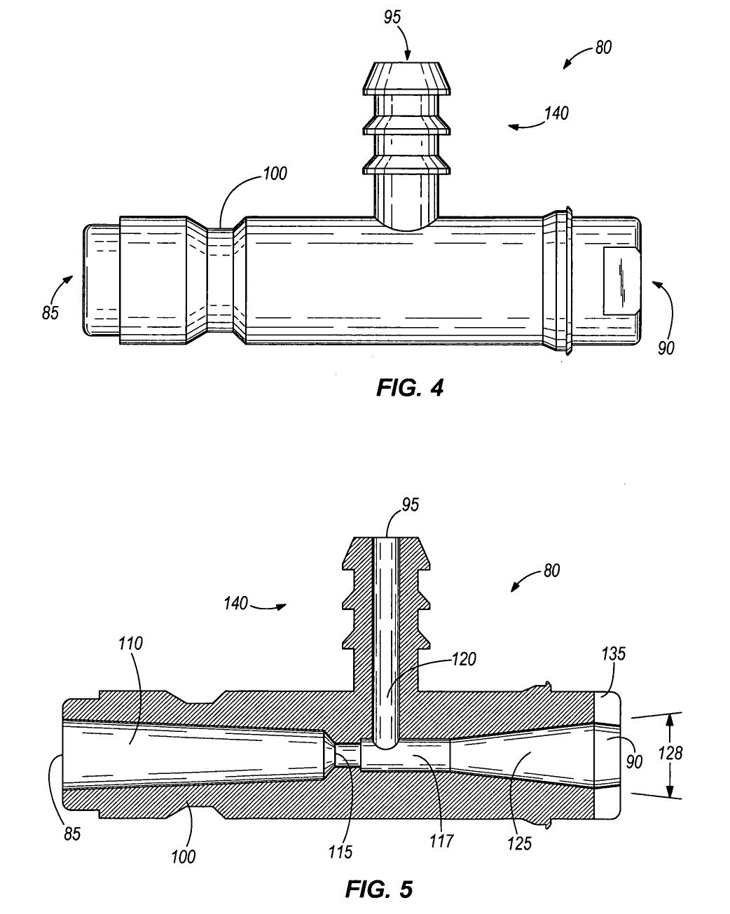

FIGS. 2-5 illustrate a nozzle body 80 that is substantially cylindrical and includes a fluid inlet 85, a fluid outlet 90, and an auxiliary inlet 95. A circumferential groove 100 exists on the exterior of the nozzle body 80 near the inlet 85. FIG. 2 best illustrates how the groove 100 is adapted to engage biased locking members 105 in the quick disconnect fitting 75 of the nozzle connector 55, as is known in the art.

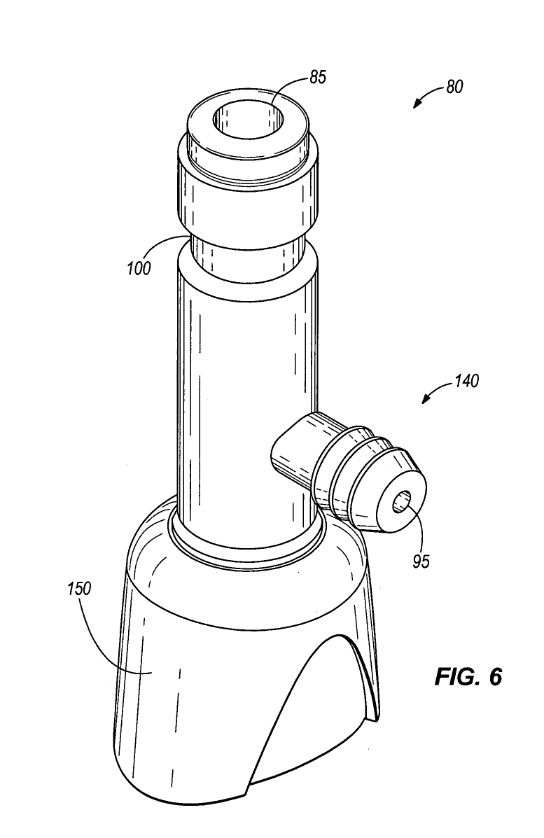

Referring to FIG. 5, the inlet 85 and outlet 90 are in fluid communication via a fluid path that includes a plurality of regions in the nozzle body 80. An inlet region 110 converges gradually to an intermediate region. The intermediate region tapers down aggressively to form a throat 115, which abruptly changes to a cylindrical segment 117 of greater diameter than the throat 115. The auxiliary inlet 95 is in fluid communication with the cylindrical segment 117 of the fluid path via an auxiliary path 120. An outlet region forms a diverging nozzle 125, and is positioned between the intermediate region and the outlet 90.

The nozzle 125 directs the high-pressure fluid in a pattern having a substantially constant diffusion angle 128. Different nozzle bodies 80 include nozzles 125 with different rates of taper to produce different diffusion angles 128. Other nozzles may include small apertures arranged at the angles that vary from 0 degrees to produce a jet or pinpoint stream, to 40 degrees or more to produce a large spray angle.

As illustrated in FIGS. 1-6, the auxiliary inlet 95 includes barbs 140 to allow an auxiliary hose 142 of appropriate diameter to be retained. A portion of one exemplary auxiliary hose 142 is illustrated in FIG. 1. The barbs 140 grip the inside surface of the auxiliary hose 142 with enough force to inhibit the unwanted removal of the auxiliary hose 142 from the nozzle body 80, without the use of a clamp. Generally, the auxiliary hose 142 can still be removed by hand. In some embodiments, the auxiliary inlet 95 may include a smooth or knurled exterior for gripping an auxiliary hose 142. Still other embodiments may include a threaded portion for attaching a hose fitting. Attaching the auxiliary hose 142 to the auxiliary inlet 95 allows a secondary fluid, such as a cleaner, to be in fluid communication with the cylindrical segment 117 of the fluid path via the auxiliary hose 142. The secondary fluid may be contained in a container placed near the operator. In some embodiments, the secondary fluid is placed in a container that attaches to the wand 25.

As pressurized fluid passes through the nozzle body 80, a venturi effect is created as the fluid flows through the intermediate region of the nozzle body 80. A drop in pressure is created in the cylindrical segment 117 of the fluid path large enough to draw the secondary fluid through the auxiliary inlet 95 and into the fluid stream before entering the nozzle 125.

In the illustrated embodiment, the nozzle body 80 is constructed from a single piece of molded plastic to simplify manufacturing and reduce cost. After initial molding of the nozzle body 80, some machining operations may be required to finish the nozzle body 80. Plastic construction is feasible because the nozzle body 80 is not subjected to the high trapped pressure within the high pressure hose 65 when the trigger 70 is disengaged. This ensures that the pressure of the pumped fluid will not exceed a desired pressure level during pump operation as the dense fluids do not pass through the length of the high pressure hose 65. Plastic construction also reduces the cost of producing the nozzle body 80, thereby making it more cost effective for an operator to replace a broken nozzle body 80, or to purchase multiple nozzle bodies 80 with varying diffusion angles for different tasks. Of course, some applications may require the nozzle body 80 to be constructed from metals such as brass, composite materials, or other materials also contemplated by the present invention.

FIG. 6 illustrates an alternative embodiment of the nozzle body 80 including a spray cover 150. The spray cover 150 is formed integral with the nozzle body 80. The spray cover 150 partially surrounds the outlet 90 of the nozzle body 80 to reduce the amount of spray that passes from the nozzle body 80 in undesirable directions. Additionally, the cover 150 helps protect the nozzle body 80 from damage that can be caused by dropping the nozzle body 80 or bumping the nozzle body 80 into objects.

The spray cover 150 of FIG. 6 is integrally formed as a single piece with the nozzle body 80 and as such inhibits rotation of the spray cover 150 with respect to the nozzle body 80. Of course, other constructions may include a spray cover 150 formed separately from the nozzle body 80 and fixedly attached to the nozzle body 80. In still other constructions, the spray cover 150 rotatably attaches to the nozzle body 80 to allow the user to position the spray cover 150 as desired.

Thus, the invention provides, among other things, a nozzle body for a pressure washer. The one-piece plastic nozzle body connects to a wand via a quick disconnect fitting and includes an auxiliary inlet to draw an auxiliary fluid into the fluid being pumped. Various features and advantages of the invention are set forth in the following claims.

What is claimed is:

1. A pressure washer comprising:
a fluid pump configured to supply a pressurized primary fluid;
a wand including a first end and a second end, the second end in fluid flow communication with the fluid pump and configured to direct the pressurized primary fluid from the second end to the first end;
a housing including an inlet end and an outlet end, the inlet end coupled to the first end of the wand;
a nozzle positioned in the outlet end of the housing and adapted to discharge the primary fluid from the pressure washer; and
an auxiliary inlet positioned between the inlet end and the outlet end, the auxiliary inlet in fluid communication with a supply of an auxiliary fluid.

2. The pressure washer of claim 1, wherein the nozzle has a tapered profile that directs the pressurized primary fluid.

3. The pressure washer of claim 1, wherein the housing defines a throat adjacent the auxiliary inlet and wherein the housing is configured such that the flow of primary fluid between the inlet end and the outlet end passes through the throat and draws in auxiliary fluid from the auxiliary inlet.

4. The pressure washer of claim 1, wherein the housing is constructed of a non-metallic material.

5. The pressure washer of claim 1, wherein the nozzle is formed integral with the housing.

6. The pressure washer of claim 1, wherein the auxiliary inlet includes a hose barb that is configured to receive a hose.

7. The pressure washer of claim 1, further comprising a cover formed integral with the housing, the cover substantially surrounding the outlet end.

8. A pressure washer comprising:
a fluid pump configured to supply a pressurized primary fluid;
a wand including a first end and a second end, the second end in fluid communication with the pump; and
a housing integrally formed as one piece and including an inlet, an outlet, an auxiliary inlet, and a nozzle formed adjacent the outlet, the inlet coupled to the first end to receive the pressurized primary fluid.

9. The pressure washer of claim 8, wherein the housing includes a portion of a quick-connect fitting formed as part of the housing and configured to connect to the first end of the wand.

10. The pressure washer of claim 8, wherein the housing is constructed of a non-metallic material.

11. The pressure washer of claim 8, wherein a fluid flow path provides fluid communication between the auxiliary inlet and a supply of an auxiliary fluid.

12. The pressure washer of claim 8, wherein the auxiliary inlet includes a hose barb configured to receive a hose.

13. The pressure washer of claim 8, wherein the housing defines a venturi.

14. The pressure washer of claim 13, wherein the auxiliary inlet is positioned adjacent the venturi.

15. The pressure washer of claim 8, wherein the nozzle has a tapered profile that directs the pressurized primary fluid.

16. The pressure washer of claim 8, wherein the housing defines a throat adjacent the auxiliary inlet and wherein the housing is configured such that the flow of primary fluid between the inlet end and the outlet end passes through the throat and draws in auxiliary fluid from the auxiliary inlet.

17. The pressure washer of claim 8, further comprising a cover formed integral with the housing, the cover substantially surrounding the outlet.

18. A nozzle housing configured to be coupled to a wand of a pressure washer, the nozzle housing comprising:
an inlet end;
an outlet end;
a fluid flow path between the inlet and outlet ends;
a nozzle positioned in the outlet end; and
an auxiliary inlet positioned between the inlet end and the outlet end;
wherein the nozzle housing is integrally formed as one piece.

19. The nozzle housing of claim 18, wherein the inlet end includes a portion of a quick-connect fitting to accommodate coupling of the nozzle housing to a wand.

20. The nozzle housing of claim 18, wherein the auxiliary inlet includes a hose barb for attaching a hose.

21. The nozzle housing of claim 18, wherein the nozzle housing is constructed from a non-metallic material.

22. The nozzle housing of claim 18, wherein the nozzle housing defines a throat adjacent the auxiliary inlet and wherein the nozzle housing is configured such that fluid flow between the inlet end and the outlet end passes through the throat and draws in auxiliary fluid from the auxiliary inlet.

23. The nozzle housing of claim 18, wherein the nozzle has a tapered profile that directs the pressurized primary fluid.

24. The nozzle housing of claim 18, wherein the nozzle housing defines a venturi.

25. The nozzle housing of claim 24, wherein the auxiliary inlet places a supply of an auxiliary fluid in fluid communication with the fluid flow path adjacent the venturi.

26. The nozzle housing of claim 18, further comprising a cover formed integral with the nozzle housing, the cover substantially surrounding the outlet end.
